(19) United States
(12) Patent Application Publication
(10) Pub. No.: US 2022/0164600 A1
(43) Pub. Date: May 26, 2022

(54) UNSUPERVISED DOCUMENT REPRESENTATION LEARNING VIA CONTRASTIVE AUGMENTATION

(71) Applicant: NEC Laboratories America, Inc., Princeton, NJ (US)

(72) Inventors: Wei Cheng, Princeton Junction, NJ (US); Haifeng Chen, West Windsor, NJ (US); Jingchao Ni, Princeton, NJ (US); Dongsheng Luo, State College, PA (US)

(21) Appl. No.: 17/528,394

(22) Filed: Nov. 17, 2021

Related U.S. Application Data
(60) Provisional application No. 63/116,215, filed on Nov. 20, 2020.

(51) Int. Cl. G06K 9/62; G06N 3/08

(52) U.S. Cl. CPC G06K 9/6256; G06N 3/088; G06K 9/6262

(57) ABSTRACT

Systems and methods for augmenting data sets is provided. The systems and methods includes feeding an original document into a data augmentation generator to produce one or more augmented documents; calculating a contrastive loss between the original document and the one or more augmented documents; and using the original document and the one or more augmented documents to train a neural network.

### RELATED APPLICATION INFORMATION

This application claims priority to U.S. Provisional Application No. 63/116,215, filed on Nov. 20, 2020, incorporated herein by reference in its entirety.

### BACKGROUND

### Technical Field

The present invention relates to neural network training, and more particularly unsupervised training using a contrasting learning approach with data augmentation techniques.

### Description of the Related Art

Deep learning is a field of machine learning where computers learn to represent and recognize things incrementally utilizing deep neural networks. When a neural network has more than one hidden layer, it may be referred to as deep.

Word embedding is the mapping of words into numerical vector spaces. Word vectors generated by algorithms like word2vec map high-dimensional word representations into a vector space with fewer dimensions. Word embedding is used for natural language processing (NLP) tasks, where machine learning models rely on vector representation as input. The representation may provide semantic and syntactic information on the words, which can improve neural network performance.

A bag-of-words approach represents text as a set of words (a vocabulary) without grammar or order information. The bag-of-words approach can be a 1-dimensional vector having a length equal to the number of words in the set, where a non-zero value at a position in the vector indicates the presence of that word in the set. The value at the position in the vector can indicate the number of times the word appears. To retain some word order information, a bag-of-n-grams approach can be used where short word sequences can be represented in the vector, rather than just individual words.

Word sense disambiguation (WSD) is the problem of determining which “sense” (meaning) of a word is activated by the use of the word in a particular context. Given a word and its possible senses, as defined by a dictionary, a system may classify an occurrence of the word in context into one or more of its sense classes. In information extraction and text mining, WSD can be involved in the accurate analysis of text in many applications.

### SUMMARY

According to an aspect of the present invention, a method is provided for augmenting data sets. The method includes feeding an original document into a data augmentation generator to produce one or more augmented documents; calculating a contrastive loss between the original document and the one or more augmented documents; and using the original document and the one or more augmented documents to train a neural network.

According to another aspect of the present invention, a system is provided for augmenting data sets. The system includes one or more processors; memory operatively coupled to the one or more processors; a data augmentation generator stored in the memory and configured to produce one or more augmented documents from an original document, and a loss calculator configured to calculate a contrastive loss between the original document and the one or more augmented documents.

According to another aspect of the present invention, a computer program product for augmenting data sets is provided. The computer program product includes readable by a computer to cause the computer to: receive an original document into a data augmentation generator to produce one or more augmented documents; calculate a contrastive loss between the original document and the one or more augmented documents; and use the original document and the one or more augmented documents to train a neural network.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating a high-level system/method for utilizing augmented documents for representational learning, in accordance with an embodiment of the present invention;

FIG. 2 is a block/flow diagram illustrating a Document Embedding via Contrastive Augmentation (DECA) system/method, in accordance with an embodiment of the present invention;

FIG. 3 is a block/flow diagram illustrating a neural network for utilizing augmented documents for representational learning, in accordance with an embodiment of the present invention;

FIG. 4 is a block/flow diagram illustrating a deep neural network for utilizing augmented documents for representational learning, in accordance with an embodiment of the present invention; and

FIG. 5 is an exemplary processing system to which the present methods and systems may be applied, in accordance with an embodiment of the present invention.

### DETAILED DESCRIPTION OF PREFERRED EMBODIMENTS

In accordance with embodiments of the present invention, a contrasting learning approach with data augmentation techniques to learn document representations in an unsupervised manner is provided. Data augmentation is a technique that generates extra samples with relatively lower quality than the original data. The extra samples' quantity and diversity have shown the effectiveness on various learning algorithm in the computer vision and speech fields. Data augmentation is a technique that generates novel and realistic-looking training data with relatively lower quality than the original data points by applying a transformation, for example, rotation and/or blurring of an image, or synonym replacement for words in a text. For example, and image of an animal or vehicle can be adjusted to appear to be from a different angle, further away, or partially obstructed, or the word “large” in an original document could be replaced with the words: big, huge, substantial, and/or not small, in one or more augmented document(s). In this manner, a small number of documents of a set on a particular subject may be increased for training a neural network without substantially altering the context and meaning of the documents.

In various embodiments, systems and methods are provided for unsupervised document embedding tasks, which can be used to train encoders that can efficiently encode documents into compact vectors to be used for different downstream tasks. The underlying semantics of a document are only partially expressed by the words that appear in it, some words in a document can be replaced, deleted, or inserted without changing the document's semantics or labelling information.

Obtaining machine-understandable representations that capturing the semantics of documents have a huge impact on various natural language processing (NLP) tasks. In one embodiment, document embedding via contrastive augmentation is provided. It reduces the classification error rate by up to 6.4% and relatively improves clustering performance by up to 7.6% compared to the second-best baselines. Surprisingly, in the classification task, the DECA method can match or even surpass fully-supervised methods. High-quality document embedding should be invariant to diverse paraphrases that preserve the semantics of the original document.

In various embodiments, contrastive learning with different augmentations for document representation learning can be used to address the challenge of data scarcity. a contrasting learning approach with data augmentation techniques to learn document representations in an unsupervised manner. data augmentations can be adopted to include more information by generating new documents that keep the same or similar semantics.

Doc2vecC computes a document embedding by simply averaging the embeddings of all words in the document. Dov2vec can learn a document embedding with context-word predictions. The document embedding matrix can be kept in memory and is jointly optimized along with word embeddings.

function that maps a document Di to a compact representation with semantics preserved The document embedding can be invariant to diverse paraphrases that preserve the semantics of the original document.

Contrastive learning is a framework that learns similar/dissimilar representations from data, based on a similarity measure and a contrastive loss function.

Contrastive loss includes a contrastive loss as a regularizer, which is joint optimized with the encoder loss l_{d} Given a batch of N documents,

Augmentation Strategies can use two augmentation methods to obtain diversely expressed documents, one is thesaurus-based substitution another is the back-translation. In various embodiments, only words inside the vocabulary are considered as replacement candidates. A thesaurus can include a list of synonyms and antonyms for each word in the documents.

Doc2vecC computes a document embedding by simply averaging the embeddings of all words in the document. Word level manipulation to generate realistic stochastic augmentation examples, such as synonym replacement, works much better than augmentations in other granularity, such as sentence-level and document-level ones. Document representation learning can obtain a low-dimensional embedding for a document that preserves its semantic meaning.

BERT stacks Transformer layers, each including a self-attention sub-layer and a feed-forward sublayer, to encode tokens in an input sequence.

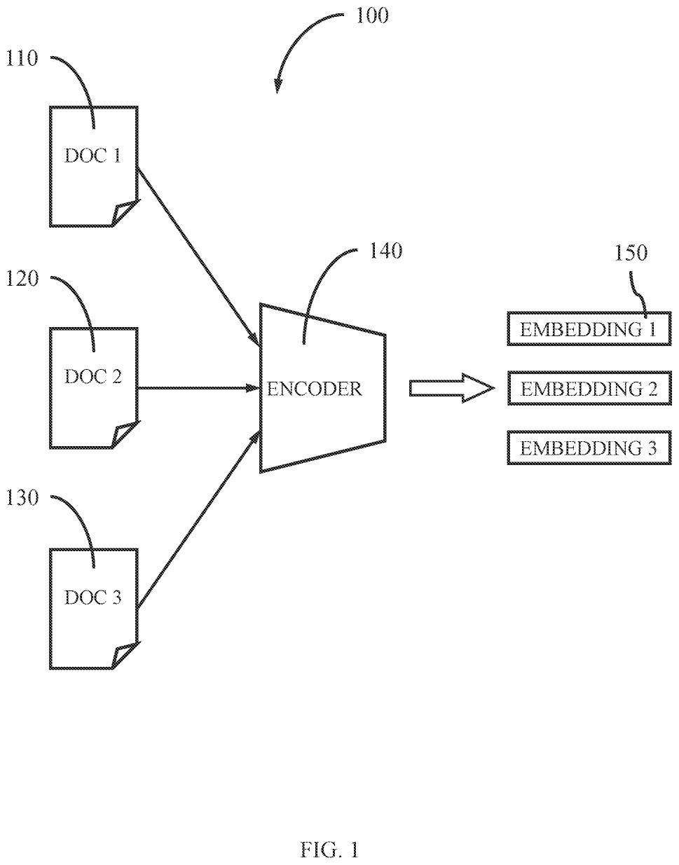

Referring now in detail to the figures in which like numerals represent the same or similar elements and initially to FIG. 1, a high-level system/method for utilizing augmented documents for representational learning is illustratively depicted in accordance with an embodiment of the present invention.

Deep learning-based methods can be utilized for long text NLP tasks. However, the quality of representations obtained by existing methods is significantly affected by the data scarcity problem, i.e., the lack of information in the low resource cases. Including more information can overcome the challenge of low resource cases. Data augmentation can generate extra samples from the original data points that can have relatively lower quality. These generated additional training samples can boost the accuracy performance of deep learning methods, where the one or more augmented documents can be provided to (e.g., fed into) and used by another neural network for training. However, it is nontrivial to select appropriate augmentation techniques under unsupervised settings without knowledge of any label information.

In one or more embodiments, a contrastive document augmentation system 100 can have a negative document 110, the original document 120, and an augmented document 130 fed into a document encoder 140 that generates a document embedding 150 for each of the inputted documents 110, 120, 130. A negative document 110, for example, of an original document of a dog image, would have any non-dog image, whereas a positive instance for an augmented document 130 could have a rotated or blurred dog image, for example. Data augmentations can be adopted to include more information by generating new documents that keep the same or similar semantics.

Contrastive learning loss aims to maximizes the consistency under differently augmented views, enabling data-specific choices to inject the desired invariance.

In various embodiments, the document encoder 140 can perform a function, denoted by ƒ: [symbol] → [symbol] ^{d×n}, which computes a low-dimensional embedding of a document [symbol] ᵢ from its BoW presentation, xᵢ.

Including data augmentation in a contrastive way can substantially improve the embedding quality in unsupervised document representation learning. Stochastic augmentations generated by simple word-level manipulation can work much better than sentence-level and document-level augmentations.

In various embodiments, the function ƒ: [symbol] → [symbol] ^{d×1} that maps a document, [symbol] ᵢ, to a compact representation with semantics preserved is learned.

[symbol] ᵢ: is the i-th document consisting of a sequence of words, wᵢ¹, wᵢ², . . . , wᵢ^{T}^{ᵢ}, where Tᵢ is the length of [symbol] ᵢ.

[symbol] ={ [symbol] ₁, [symbol] ₂, . . . , [symbol] ₙ,}: is a text corpus with n=| [symbol] | documents.

[symbol] : is the vocabulary in the corpus [symbol] , with the size v=| [symbol] |.

xᵢ∈ [symbol] ^{v×1}: the BoW representation vector of document [symbol] ᵢ, similar to one-hot coding, xᵢⱼ=1 iff word j appears in document [symbol] ᵢ.

hᵢ∈ [symbol] ^{d×1}: the compact representation of document [symbol] ᵢ, with d as the dimensionality.

[symbol] ᵢ: is a document generated by applying augmentations on [symbol] ᵢ.

\tilde{x}ᵢ∈ [symbol] ^{v×1}, \tilde{h}ᵢ∈ [symbol] ^{d×1}: are the BoW representation and compact representation of the augmented document [symbol] ᵢ, respectively.

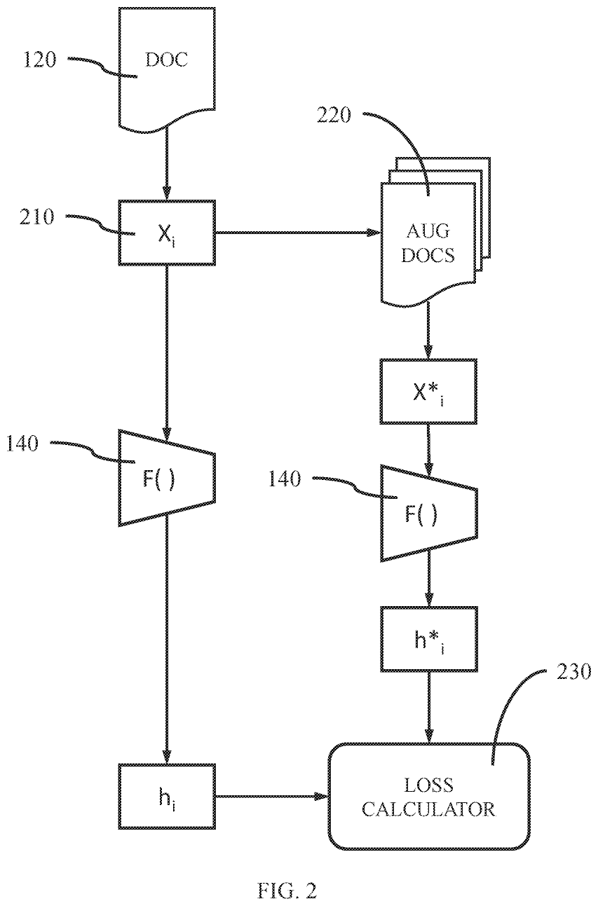

FIG. 2 is a block/flow diagram illustrating a Document Embedding via Contrastive Augmentation (DECA) system/method, in accordance with an embodiment of the present invention.

In various embodiments, a stochastic data augmentation generator 210 creates new augmented document(s) 220, [symbol] ᵢ, from an inputted original document(s) 120, [symbol] ᵢ, where the augmented documents 220 can be generated, for example, by word replacement with synonym(s), back propagation, and/or negative replacement. In various embodiments, for each document [symbol] ᵢ, an augmented document [symbol] ᵢ is generated by the stochastic data augmentation module 210.

In various embodiments, the document encoder 140 can compute the low-dimensional embedding of the original document(s) 120 and new augmented document(s) 220 using the function, ƒ: [symbol] → [symbol] ^{d×n}. Doc2vecC can be used to compute the document embeddings, xᵢ, \tilde{x}ᵢ, as the mean of its word embeddings, and motivated by the semantic meaning of linear operations on word embeddings calculated by Word2Vec.

$${h}_{i} ≡ f ( {𝒟}_{i} ) = \frac{1}{{T}_{i}} U {x}_{i} ,$$

where U serves as the word embedding matrix.

$$P ( {w}^{t} \vert {c}^{t} , x ) = \frac{exp ( {ν}_{{w}^{′}}^{T} , ( U {c}^{t} + h ) )}{{Σ}_{{w}^{′} ∈ V} exp ( {ν}_{{w}^{′}}^{T} , ( U {c}^{t} + h ) )} ;$$

where U serves as the word embedding matrix, c^{t}, is the local context of the target word, w^{t}, in document D, and [symbol] is a learnable projection matrix. To optimize U, Doc2vecC extends the Continuous Bag of Words Model (CBOW) model by treating the document as a special token to the context and maximize the following probability for a target word, w^{t}.

The element-wise loss function of Doc2vecC is:

[symbol]

_{d}⁽ⁱ⁾==−Σₜ₌₁^{T}^{ᵢ} log P(wᵢ^{t}|cᵢ^{t},xᵢ);

where the sum of the loss is [symbol] _{d}=Σᵢ₌₁^{N} [symbol] _{d}⁽ⁱ⁾.

Contrastive loss is introduced as a regularizer, which is jointly optimized with the encoder loss, [symbol] _{d}, to leverage the augmented data for better embedding quality. The contrastive loss simply regularizes the embedding model to be invariant to diverse paraphrases that preserve the semantics of the original document. Encouraging consistency on the augmented examples can substantially improve the sample efficiency.

For each document [symbol] ᵢ, an augmented document [symbol] ᵢ is generated by the stochastic data augmentation module 210 for a batch of N documents. [symbol] [symbol] ᵢ, [symbol] ᵢ [symbol] is treated as a positive pair, and the other N−1 pairs, [symbol] [symbol] ᵢ, [symbol] ₖᵢ [symbol] _{i≠k} are considered as negative pairs. The contrastive loss aims to identify [symbol] ᵢ out of the augmented documents in the batch for an input document [symbol] ᵢ.

The sample-wise contrastive loss is:

$${ℓ}_{c}^{( i )} = - log \frac{exp ( cos ( {h}_{i} , {\tilde{h}}_{i} ) / τ )}{{Σ}_{k = 1}^{N} {Π}_{[ k \neq i ]} exp ( cos ( {h}_{i} , {\tilde{h}}_{i} ) / τ )} , \qquad$$

where hᵢ and \tilde{h}ᵢ are document embeddings calculated by the embedding function; cos( ) denotes the cosine similarity between vectors, and r is the temperature parameter. In FIG. 2, \tilde{x}ᵢ and \tilde{h}ᵢ are represented by x*ᵢ and h*ᵢ, respectively.

The sum of the loss is [symbol] _{c}Σᵢ₌₁^{N} [symbol] _{c}⁽ⁱ⁾.

With the contrastive loss [symbol] _{c} as a regularization term, the objective function minimizes the following loss function: P A loss calculator 230 can calculate the consistency loss of contrastive loss [symbol] _{c}. The contrastive loss means positive pairs are similar and far from negative ones. This denotes the consistence between one sample and the augmented one.

Within the SimSaim framework, a prediction MLP with Batch Normalization is first applied to get output vectors: zᵢ=f(hᵢ) and \tilde{z}ᵢ=f(\tilde{h}ᵢ). The negative cosine similarity between hᵢ, \tilde{z}ᵢ and \tilde{h}ᵢ, zᵢ can be minimized. Stop gradient can be used to avoid a collapsed solution.

The function D(⋅;) is the negative cosine similarity.

[symbol]

= [symbol] _{d}+λ [symbol] _{c}=Σᵢ₌₁^{N}[−Σₜ₌₁^{T}^{ᵢ} log P(wᵢ^{t}|c_{c}^{t},xᵢ)+λ [symbol] _{c}ⁱ];

where λ is a hyper-parameter to set the tradeoff between the two loss components.

When BERT is adopted as the backbone, we directly fine-tune it with the contrastive loss [symbol] _{c}.

Generating realistic augmented examples that preserve the semantics of original documents in an efficient way is non-trivial. The input document can be paraphrased by replacing words based on synonyms, antonym with a negative prefix, or their frequencies, and at the same time, keep its semantics. With Synonyms Replacement, for each word, we first extract a set of replacement candidates using WordNet Synsets and filter out the ones out of vocabulary or with low frequencies. For efficient computation, the original word is also included in its synonym set. To generate an augmented document, for each word, we randomly select a word in the set of its replacement candidates.

For Negative Antonym Replacement, an adjective or a verb can be replaced by its antonym with a negative prefix, like “not”.

For Uninformative Word Replacement, the low frequent words can be replaced with synonyms with high frequencies.

The underlying semantics of a document may only be partially expressed by the document itself.

Back-Translation first translates a document D from the original language (English in this study) to another language, like German and French, to get D′. Then, the document D′ is translated back to the original language as the augmented document D*. document level back-translation can generate paraphrases with high diversities while preserving the semantics.

A wide range of document corpora, including sentiment analysis (MR, IMDB), news classification (R8, R52, 20news), and medical literature (Ohsumed), are adopted.

The embedding dimensionality is set to 100, except for Transformer-based models, whose output dimension is 768. For each dataset, we first use all documents to learn an embedding for each one. Then, these document embeddings will be evaluated with two downstream tasks, linear classification and clustering.

Logistic regression is adopted as the classifier and the testing error rate is used as the evaluation metric.

Data augmentations used in DECA generate new documents with relatively low qualities, enriching the diversity of the text dataset, which addresses the low resource problem. DECA is also more robust to noise introduced in the augmented texts, which equips DECA with more flexibility to choose different augmentation methods and leads to embeddings with higher quality. The newly generated documents and original documents can then be used to train a neural network.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be outputted.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In instances where a neural network is intended to predict the nature of a subsequent input from previously inputted data, the neural network can be structured to capture the time evolution of the input data. This may be accomplished by providing for a time delay in inputting each subsequent data value. This can provide a short term memory for the input data by exposing the nodes to the input data in a sequence, where the data itself can have an inherent time sequence.

The memory of a neural network can be increases by feeding the output generated by a node back as an input with a time delay. This allows previously inputted data to affect the output of the subsequently inputted data. However, the effect of earlier data can decay quickly.

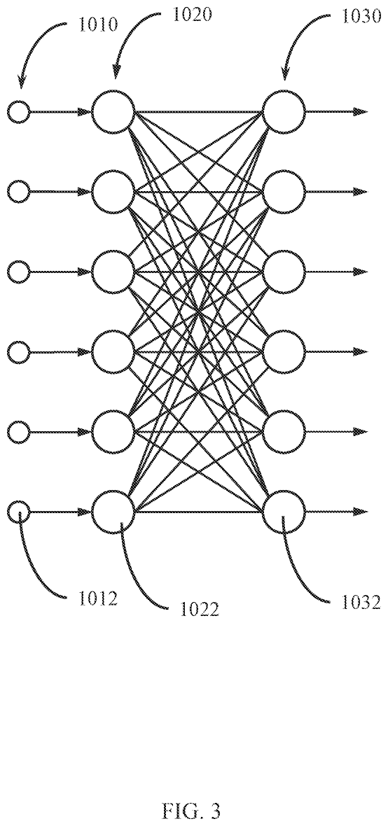

FIG. 3 is a block/flow diagram illustrating a neural network for utilizing augmented documents for representational learning, in accordance with an embodiment of the present invention.

In layered neural networks, nodes are arranged in the form of layers. An exemplary simple neural network has an input layer 1020 of source nodes 1022, and a single computation layer 1030 having one or more computation nodes 1032 that also act as output nodes, where there is a single computation node 1032 for each possible category into which the input example could be classified. An input layer 1020 can have a number of source nodes 1022 equal to the number of data values 1012 in the input data 1010. The data values 1012 in the input data 1010 can be represented as a column vector. Each computation node 1032 in the computation layer 1030 generates a linear combination of weighted values from the input data 1010 fed into input nodes 1020, and applies a non-linear activation function that is differentiable to the sum. The exemplary simple neural network can preform classification on linearly separable examples (e.g., patterns).

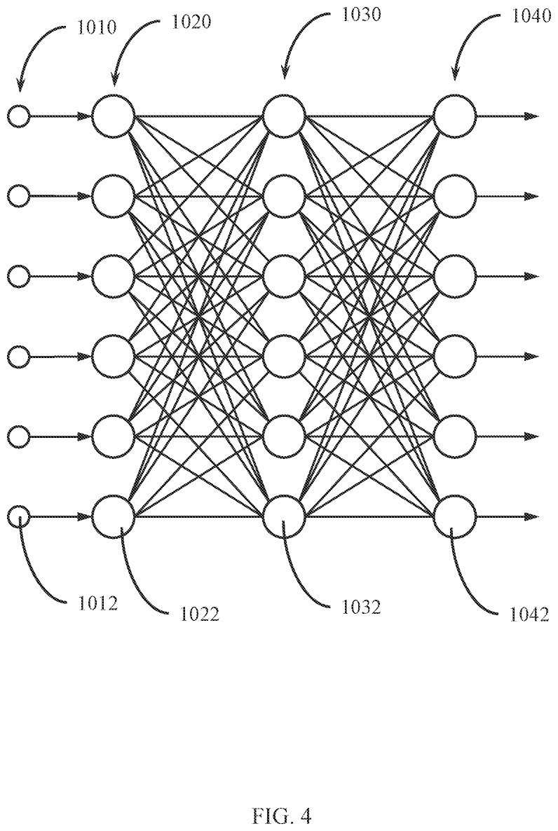

FIG. 4 is a block/flow diagram illustrating a deep neural network for utilizing augmented documents for representational learning, in accordance with an embodiment of the present invention.

A deep neural network, such as a multilayer perceptron, can have an input layer 1020 of source nodes 1022, one or more computation layer(s) 1030 having one or more computation nodes 1032, and an output layer 1040, where there is a single output node 1042 for each possible category into which the input example could be classified. An input layer 1020 can have a number of source nodes 1022 equal to the number of data values 1012 in the input data 1010. The computation nodes 1032 in the computation layer(s) 1030 can also be referred to as hidden layers, because they are between the source nodes 1022 and output node(s) 1042 and are not directly observed. Each node 1032, 1042 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the inputted data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated. Parameters U, V can be updated through backpropagation.

The computation nodes 1032 in the one or more computation (hidden) layer(s) 1030 perform a nonlinear transformation on the input data 1012 that generates a feature space. The classes or categories may be more easily separated in the feature space than in the original data space.

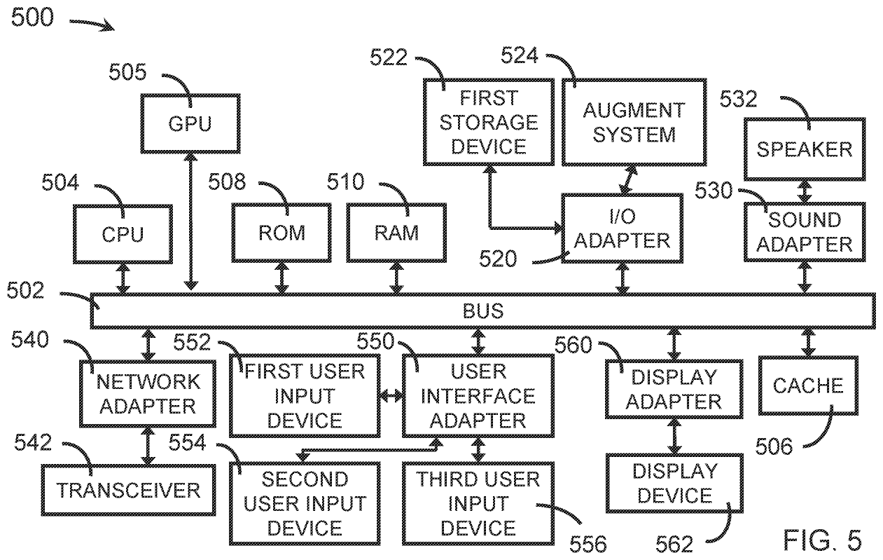

FIG. 5 is an exemplary processing system to which the present methods and systems may be applied, in accordance with an embodiment of the present invention.

The processing system 500 can include at least one processor (CPU) 504 and may have a graphics processing (GPU) 505 that can perform vector calculations/manipulations operatively coupled to other components via a system bus 502. A cache 506, a Read Only Memory (ROM) 508, a Random Access Memory (RAM) 510, an input/output (I/O) adapter 520, a sound adapter 530, a network adapter 540, a user interface adapter 550, and/or a display adapter 560, can also be operatively coupled to the system bus 502.

A first storage device 522 and a second storage device 524 are operatively coupled to system bus 502 by the I/O adapter 520, where a recurrent neural network for generating augmented documents can be stored for implementing the features described herein. The storage devices 522 and 524 can be any of a disk storage device (e.g., a magnetic or optical disk storage device), a solid state storage device, a magnetic storage device, and so forth. The storage devices 522 and 524 can be the same type of storage device or different types of storage devices. The a contrastive document augmentation system 100 can be stored in the storage device 524 and implemented by the at least one processor (CPU) 504 and/or the graphics processing (GPU) 505.

A speaker 532 can be operatively coupled to the system bus 502 by the sound adapter 530. A transceiver 542 can be operatively coupled to the system bus 502 by the network adapter 540. A display device 562 can be operatively coupled to the system bus 502 by display adapter 560.

A first user input device 552, a second user input device 554, and a third user input device 556 can be operatively coupled to the system bus 502 by the user interface adapter 550. The user input devices 552, 554, and 556 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 552, 554, and 556 can be the same type of user input device or different types of user input devices. The user input devices 552, 554, and 556 can be used to input and output information to and from the processing system 500.

In various embodiments, the processing system 500 may also include other elements (not shown), as readily contemplated by one of skill in the art, as well as omit certain elements. For example, various other input devices and/or output devices can be included in processing system 500, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 500 are readily contemplated by one of ordinary skill in the art given the teachings of the present principles provided herein.

Moreover, it is to be appreciated that system 500 is a system for implementing respective embodiments of the present methods/systems. Part or all of processing system 500 may be implemented in one or more of the elements of FIGS. 1-2. Further, it is to be appreciated that processing system 500 may perform at least part of the methods described herein including, for example, at least part of the method of FIGS. 1-2.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

1. A method for augmenting data sets, comprising:
feeding an original document into a data augmentation generator to produce one or more augmented documents;
calculating a contrastive loss between the original document and the one or more augmented documents; and
using the original document and the one or more augmented documents to train a neural network.

2. The method as recited in claim 1, wherein at least one of the one or more augmented documents is generated by replacing a word in the original document with a synonym.

3. The method as recited in claim 1, wherein at least one of the one or more augmented documents is generated by replacing a word in the original document with an antonym with a negative prefix before the antonym.

4. The method as recited in claim 1, wherein at least one of the one or more augmented documents is generated by rotating and/or blurring a digital image.

5. The method as recited in claim 1, wherein at least one of the one or more augmented documents is generated by using Doc2vecC to compute an embedding for the original document, and calculating a contrastive loss for the embedded document.

6. The method as recited in claim 5, wherein contrastive loss is calculated using:
$${ℓ}_{c}^{( i )} = - log \frac{exp ( cos ( {h}_{i} , {\tilde{h}}_{i} ) / τ )}{{Σ}_{k = 1}^{N} {Π}_{[ k \neq i ]} exp ( cos ( {h}_{i} , {\tilde{h}}_{i} ) / τ )} . \qquad$$

7. The method as recited in claim 6, wherein a sum of the contrastive losses is calculated using: [symbol] _{c}=Σᵢ₌₁^{N} [symbol] _{c}⁽ⁱ⁾.

8. A system for augmenting data sets, comprising:
one or more processors;
memory operatively coupled to the one or more processors; and
a data augmentation generator stored in the memory and configured to produce one or more augmented documents from an original document, and
a loss calculator configured to calculate a contrastive loss between the original document and the one or more augmented documents.

9. The system as recited in claim 8, wherein the data augmentation generator is further configured to generate at least one of the one or more augmented documents by replacing a word in the original document with a synonym.

10. The system as recited in claim 8, wherein the data augmentation generator is further configured to generate at least one of the one or more augmented documents by replacing a word in the original document with an antonym with a negative prefix before the antonym.

11. The system as recited in claim 8, wherein the data augmentation generator is further configured to generate at least one of the one or more augmented documents by rotating and/or blurring a digital image.

12. The system as recited in claim 8, wherein the data augmentation generator is further configured to generate at least one of the one or more augmented documents by using Doc2vecC to compute an embedding for the original document, and calculating a contrastive loss for the embedded document.

13. The system as recited in claim 12, wherein contrastive loss is calculated using:
$${ℓ}_{c}^{( i )} = - log \frac{exp ( cos ( {h}_{i} , {\tilde{h}}_{i} ) / τ )}{{Σ}_{k = 1}^{N} {Π}_{[ k \neq i ]} exp ( cos ( {h}_{i} , {\tilde{h}}_{i} ) / τ )} . \qquad$$

14. The system as recited in claim 13, wherein a sum of the contrastive losses is calculated using: [symbol] _{c}=Σᵢ₌₁^{N} [symbol] _{c}⁽ⁱ⁾.

15. A computer program product for augmenting data sets, the computer program product comprising a computer readable storage medium having program instructions embodied therewith, the program instructions readable by a computer to cause the computer to:
receive an original document into a data augmentation generator to produce one or more augmented documents;
calculate a contrastive loss between the original document and the one or more augmented documents; and
use the original document and the one or more augmented documents to train a neural network.

16. The computer program product as recited in claim 15, wherein at least one of the one or more augmented documents is generated by replacing a word in the original document with a synonym.

17. The computer program product as recited in claim 15, wherein at least one of the one or more augmented documents is generated by replacing a word in the original document with an antonym with a negative prefix before the antonym.

18. The computer program product as recited in claim 15, wherein at least one of the one or more augmented documents is generated by rotating and/or blurring a digital image.

19. The computer program product as recited in claim 15, wherein at least one of the one or more augmented documents is generated by using Doc2vecC to compute an embedding for the original document, and calculating a contrastive loss for the embedded document.

20. The computer program product as recited in claim 19, wherein contrastive loss is calculated using:
$${ℓ}_{c}^{( i )} = - log \frac{exp ( cos ( {h}_{i} , {\tilde{h}}_{i} ) / τ )}{{Σ}_{k = 1}^{N} {Π}_{[ k \neq i ]} exp ( cos ( {h}_{i} , {\tilde{h}}_{i} ) / τ )} ; \qquad$$
and wherein a sum of the contrastive losses is calculated using: [symbol] _{c}=Σᵢ₌₁^{N} [symbol] _{c}⁽ⁱ⁾.
